(19) United States
(12) Patent Application Publication
(10) Pub. No.: US 2005/0033942 A1
(43) Pub. Date: Feb. 10, 2005

(54) Distribution of architectural state information in a processor across multiple pipeline stages

(76) Inventors: Simcha Gochman, Timrat (IL); Robert Valentine, Qiryat Tivon (IL); Rafael Spigelman, Ramat Yishai (IL); Gregory Pribush, Beer Sheva (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/637,417

(22) Filed: Aug. 8, 2003

(51) Int. Cl. G06F 9/30

(52) U.S. Cl. 712/218

(57) ABSTRACT

Methods and apparatuses for distributing architectural state information in a processor across multiple pipeline stages are described. An architectural value of a register is represented by a historical value added to an update value which is maintained in a non-final pipeline stage. When an instruction requires the architectural value, a calculation is made and that value is inserted into the pipeline for processing. Recovery of both pre- and post-execution architectural state information is made possible by storing both the update value and the operation to take place on that value for each decoded instruction.

### TECHNICAL FIELD

The invention relates to pipelined processor architectures. More particularly, the invention relates to distribution of register values across multiple pipeline stages.

### BACKGROUND

Current processor architectures include one or more registers that are used for specific purposes. For example, a processor may have a stack pointer that is used to point to the head (or tail) of a stack. The value of the stack pointer is incremented and decremented by a fixed amount as values are added (pushed) to the stack and read (popped) from the stack. Because stack activity is common as a processor executes instruction code, the increments and decrements to the stack pointer value are frequent occurrences.

The mathematical operation that increments or decrements (i.e., an addition operation or a subtraction operation) the register value is performed by an arithmetic unit that is part of the execution stage circuitry of the processor pipeline. However, the increment and decrement operations are typically values such as 2, 4 or 8, which requires only a relatively simple addition or subtraction operation instead of the more complex arithmetic operations that are supported by the arithmetic units. Thus, use of the arithmetic unit in the execution stage of a processor pipeline for simple addition or subtraction of small values results in inefficient use of processor resources.

### BRIEF DESCRIPTION OF THE DRAWINGS

The invention is illustrated by way of example, and not by way of limitation, in the figures of the accompanying drawings in which like reference numerals refer to similar elements.

FIG. 1 is a simplified block diagram of pipeline units in a processor.

FIG. 2 is a block diagram of a recovery and update circuit.

FIG. 3 illustrates one embodiment of circuitry for the distribution of architectural state information.

FIG. 4 is a flowchart of one embodiment of operation of a processor having distributed architectural state information.

FIG. 5 is a block diagram of a pipelined processor containing circuitry for the distribution of architectural state information.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Many processors have registers with specific behaviors. Examples of these include the index registers in the MOStech 6502 processor family, counter registers in various digital signal processors (DSPs), and the stack pointer (ESP) in the 32-bit Intel Architecture (IA32) family of processors. Other processors that have only general-purpose registers will sometimes have a stereotypical behavior (incremented or decremented by a predetermined value or a multiple of the predetermined value) with certain registers when a software convention is used that uses a register for a specific purpose, for example, a stack pointer. This stereotypical behavior may be hidden within instructions, for instance the post- and pre-increment/decrement addressing modes common in mini-computers such as VAX and MRX systems.

Typically, registers are part of a register file with a fixed latency to the execution stages. Updates occur in the execution stage and all registers use the same amount of execution bandwidth to be maintained. Thus, registers storing values that are incremented or decremented (also referred to herein as “stereotypic behavior”) use the same amount of execution bandwidth as more complex operations. As described in greater detail below, an architecture register (Rₐ) can be distributed across two or more stages of the pipeline. In one embodiment, Rₐ can also be software-accessible. A historical copy of the full register value is maintained in the register file (R_{f}) and can be updated during the execution stage. There is also an update value (Rᵤ) stored in the decoders that accumulates the stereotypic changes (i.e., increments and/or decrements) that have occurred. Thus, the architectural state is given by:
Rₐ=R_{f}+Rᵤ

Distributing these contents provides several advantages over conventional stereotypic register updates. Removing the additions and subtractions associated with increments and decrements from the execution stage frees execution bandwidth for other operations. Multiple operations can be accomplished per cycle, which can allow dependency chains to be collapsed more efficiently.

Register usage other than increments and decrements can be supported, for example, by detecting a register operation in the address generation unit. When a request for the value Rₐ is detected, the decoders or other processor circuitry replace Rₐ by inserting the quantity R_{f}+Rᵤ into the instruction. The collapsing of the dependency chain can increase the memory operations to be initiated in parallel because R_{f} is available and Rᵤ can be updated multiple times during a cycle.

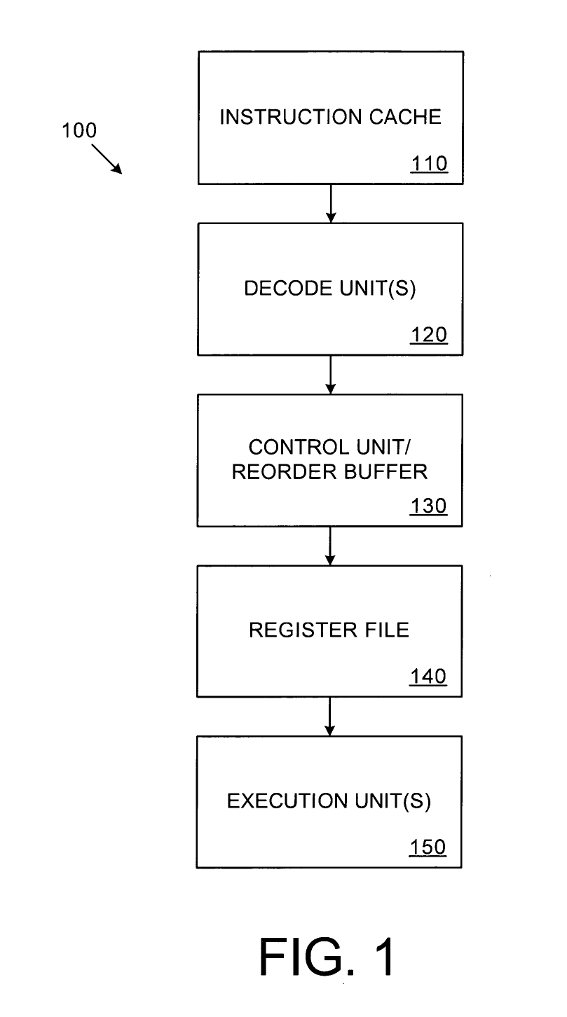

FIG. 1 is a simplified block diagram of pipeline units in a processor. The architecture of FIG. 1 is a simple three-stage architecture; however, the techniques described herein can be applied to an architecture having any number of pipeline stages. A simple architecture is presented for purposes of simplicity of description of the register usage as described herein.

In general, processor 100 includes instruction cache 110, decode unit(s) 120, execution unit(s) 150, control unit/reorder buffer 130 and register file 140. Processor 100 typically includes additional components that are not included in FIG. 1, for example, a branch prediction buffer, a data cache, an address generation unit. Instructions enter and exit the circuitry of each stage of the pipeline in unison. For example, on each clock cycle, pipeline stage circuitry transmits an instruction to the next pipeline stage. Different processor architectures have different numbers of pipeline stages.

Instruction cache 110 provides one or more instructions to decode unit(s) 120. Various configurations of decode units are known in the art. Decode unit(s) 120 provide data to control unit/reorder buffer 130 which reorders the instructions (if necessary and if instructions can be executed out of order). Register file 140 receives the output of control unit/reorder buffer 130 and accesses registers as needed by execution unit(s) 150. Execution unit(s) 150 performs arithmetic operations on the data and writes instruction results to one or more registers in register file 140. In prior art architectures, as the result of stereotypic behavior, one or more registers in register file 140 are updated upon completion of the final pipeline stage.

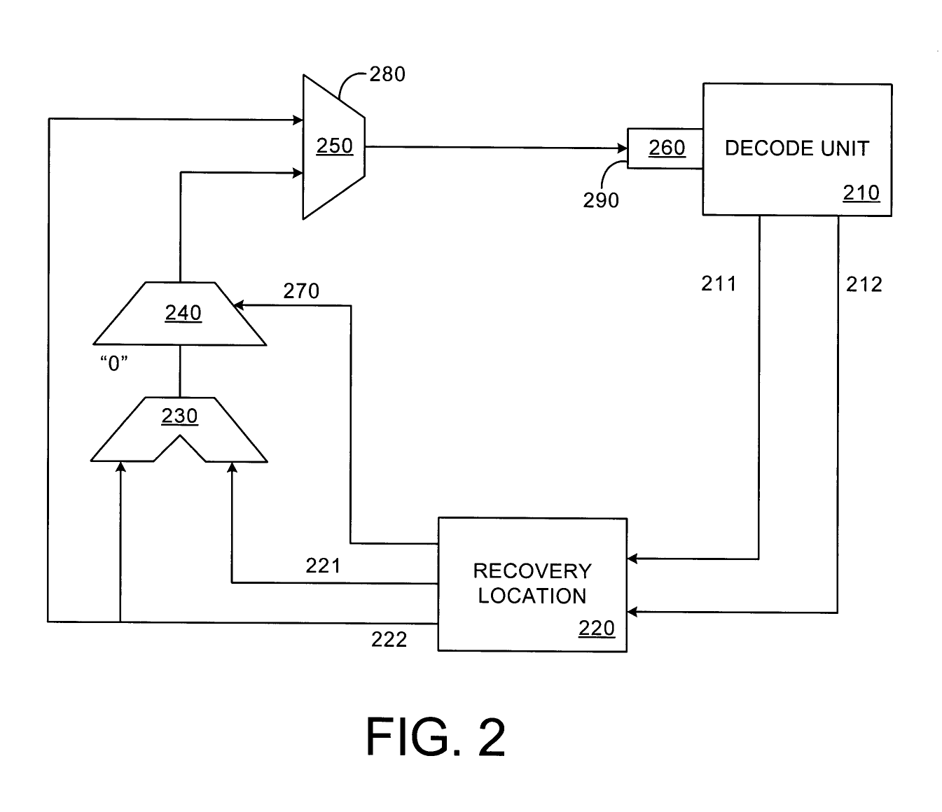

FIG. 2 is a block diagram of a recovery and update circuit. In one embodiment, decode unit 210 includes one decoder but a system comprising multiple decoders could be implemented. In the process of decoding an instruction, decode unit 210 sends the value of Rᵤ to recovery location 220 via line 212. Line 211 carries a copy of the operation to be performed on the value of Rᵤ during execution to recovery location 220. In one embodiment, storing both the value of Rᵤ and the operation to be performed on the value of Rᵤ is performed as the instructions pass through the decode stage of the pipeline.

Storing the value of Rᵤ and the operation to be performed on the value of Rᵤ allows for recovery of both the pre-execution value and the post-execution value of Rᵤ. Storing Rᵤ and the operation to be performed on the value of Rᵤ allows for handling of either faults or traps in an embodiment utilizing the IA32 architecture. Alternatively, pre- and post-execution values of Rᵤ are stored. However, in an embodiment using the IA32 architecture, the stored operation to be performed on the stored value of Rᵤ can be contained in 3 bits, whereas the post-execution value of Rᵤ requires 7 bits. Thus, a single byte-wide adder can be used allowing for significant storage reduction.

When a speculative path has been taken erroneously, the correct value of Rᵤ is recovered and reinserted into the pipeline for execution. Line 222 carries the pre-execution value of Rᵤ to arithmetic unit 230. The pre-execution value of Rᵤ is also sent to mux 250. Line 221 carries the stored copy of the operation to take place on Rᵤ to arithmetic unit 230. Arithmetic unit 230 carries out the operation on the value of Rᵤ and sends the result to mux 240. The result is then sent through mux 240 and becomes an input to mux 250 except in cases where control line 270 is enabled to select “0” as the output of mux 240.

When logic in the processor determines that a speculative path is erroneous, the processor logic then determines whether the pre- or post-execution value of Rᵤ needs to be recovered. In one embodiment, control line 280 is enabled when the processor logic determines that the post-execution value of Rᵤ is needed. Also, when the processor logic determines a speculative path to be erroneous, control line 290 is enabled to allow the recovered value of Rᵤ to be written to the register and subsequently read during the decode stage.

In an embodiment using the IA32 architecture, the “set to zero” operation, which takes place at mux 240 when control line 270 is enabled, is implemented for the LEAVE instruction. However, the “set to zero” operation could be implemented for any instruction that overwrites Rᵤ (e.g. a MOV instruction).

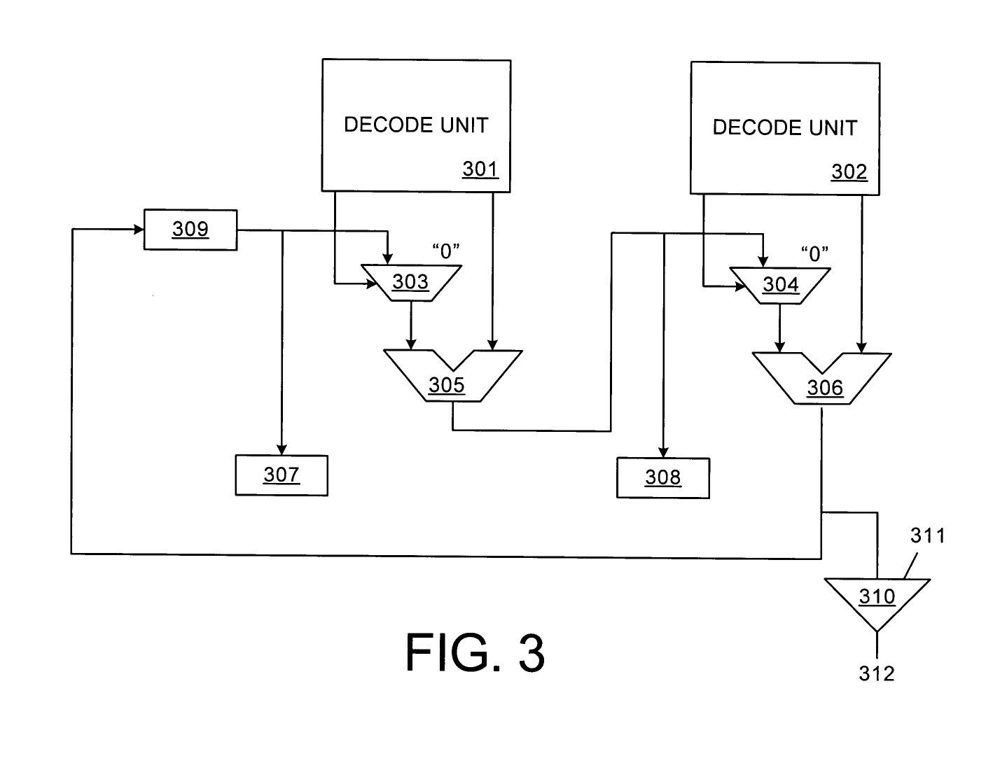

FIG. 3 illustrates one embodiment of maintaining (incrementing and decrementing) a value stored in Rᵤ during the decode stage of a processor pipeline. In one embodiment, a three wide decoder is implemented. FIG. 3 illustrates a two wide version of the mechanism, which shows the functionality to extend its use to any desired width. The “ripple” or “cascade” effect shown in FIG. 3 demonstrates only one embodiment of this mechanism. Other embodiments can achieve implementation of the mechanism without using a ripple add.

In one embodiment, decode units 301 and 302 have two functions that take place for each instruction. Each unit determines if the instruction requires a “sync” operation due to the requiring of the value of Rₐ. When an instruction (e.g. loads and stores) requires the value of Rₐ, the value is calculated by adding the accumulated update value, Rᵤ, to the historic value, R_{f}, where the result can then be sent to the address generation unit (AGU). After Rₐ has been calculated, R_{f} is equal to Rₐ inasmuch as Rₐ has a new history after the calculation. Thus, to satisfy the equation:
Rₐ=R_{f}+Rᵤ,
Ru must equal zero. As an example, when a sync operation is required, decode unit 301 sends a control signal to mux 303 which then selects the “0” input as its output going to arithmetic unit 305. A sync operation is not generated when Rᵤ is zero, so that continued usage of Rₐ as a general-purpose register will have no ill effects.

A sync operation may not be required for instructions such as loads and stores in an embodiment that includes a processor capable of doing three-input adds. The instruction Rₐ=Rₐ+K, where K is a register of immediate data, is offered as an example. Because the processor is capable of receiving three inputs, the instruction can be executed as Rₐ=R_{f}+Rᵤ+K. Thus, a sync operation is not needed because Rₐ is not being used. A processor faced with a divide instruction (e.g. N=M/Rₐ) could be executed in similar fashion (i.e. N=M/(R_{f}+Rᵤ)), though it is unlikely that a processor would have the complex hardware needed to carry out such an operation. Hence, a sync operation would be required corresponding to the use of Rₐ.

A second function of the decode units is to provide an update value (or 0) to be added to or subtracted from the value in Rᵤ if the instruction is performing a stereotypic operation on Rₐ. The value of Rᵤ is contained in register 309 and is sent to mux 303 where it is either selected or set to zero for a sync operation. The value is then passed to arithmetic unit 305 where the update value is added to the value stored in Rᵤ, thereby accumulating the stereotypic changes.

Rᵤ can be further updated by sending the output of arithmetic unit 305 to the input of mux 304. Decode unit 302 performs the same procedure as decode unit 301 as described above. Eventually, depending on the degree of parallelism, the results of the updates are sent back to register 309 where Rᵤ is written. As each new set of instructions reach the various decode units, the process of updating Rᵤ begins anew.

As the update results are being sent to Rᵤ, the update results are compared to an overflow threshold or “watermark” by comparator 310. When the value of Rᵤ output from arithmetic unit 306 is greater than watermark 311, flag 312 is set indicating that there is a potential for overflow of Rᵤ on the next set of instructions incoming to the decode units. When flag 312 is set, the sync operation for decoder 301 is performed on the next cycle to prevent overflow from occurring.

Boxes 307 and 308 represent sync instructions and their inclusion in FIG. 3 demonstrates that the current updated value of Rᵤ is always available to each instruction for use in a sync operation.

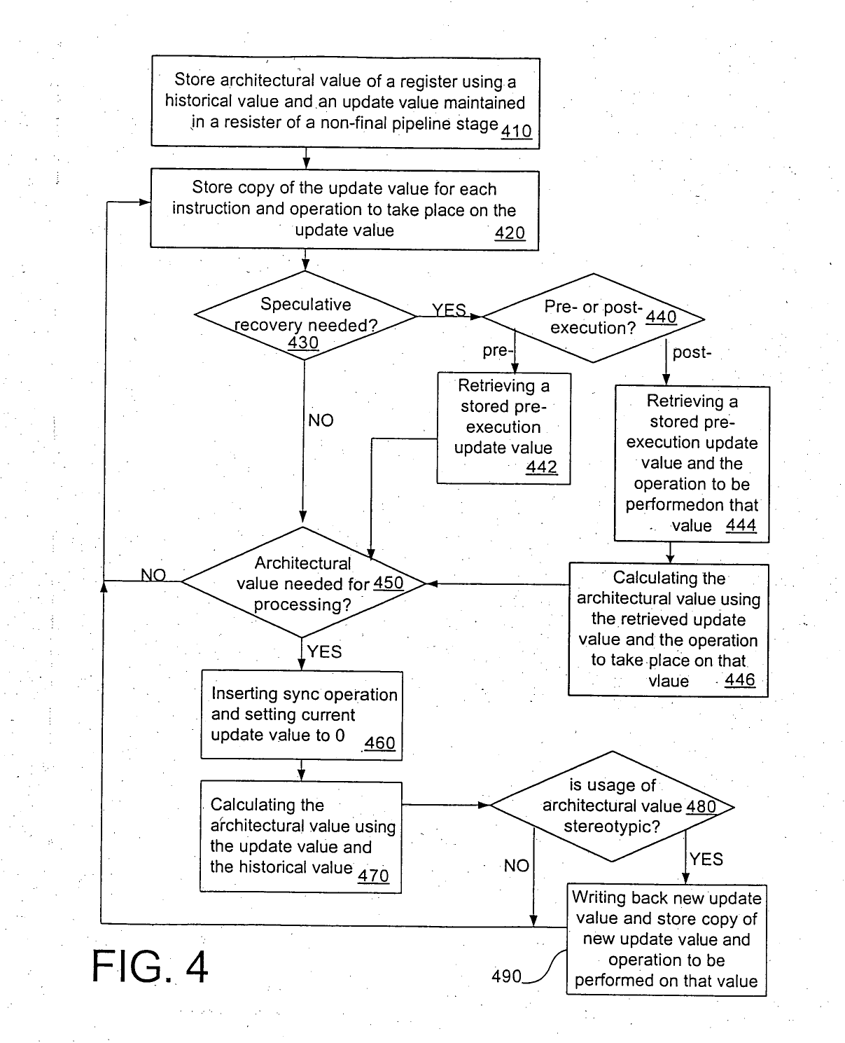

FIG. 4 is flowchart illustrating one embodiment of operation of a processor having distributed architectural state information. An architectural value of a register (e.g. Rₐ) is represented by summation of a historical value (R_{f}) and an update value (Rᵤ) maintained in a register of a non-final pipeline stage at block 410. One of the advantages of representing the value of Rₐ in this way is that dependencies on Rₐ are removed because the value of R_{f} used for scheduling in the out-of-order machine is not changed during the sequence of stack operations. This allows more parallelism opportunities to be realized in the out-of-order execution. Also, updates on Rᵤ are performed using a dedicated adder that can be smaller than the execution stage adder, thus freeing the general execution units to perform other operations.

When Rᵤ is updated, a copy of the update value, along with the operation to be performed on that value, is stored in a recovery location, illustrated in block 420. Storage locations include buffers such as a reorder buffer or a history buffer. The recovery location can have one set of inputs or several, depending on the overall width of the decoding units.

At decision block 430, circuitry in the decode stage determines whether a speculative recovery of Rᵤ is needed during execution of a particular instruction. If speculative recovery is needed, the processor determines whether the pre- or post-execution value of Rᵤ is needed as illustrated at 440. Once the pre- or post-execution value of Rᵤ is ready, the processor determines whether Rₐ is needed for processing the instruction, illustrated at 450. If Rₐ is needed, then a sync operation is inserted, Rᵤ is set to 0 and Rₐ is calculated as shown in blocks 460 and 470.

Once the value of Rₐ is calculated, the processor determines whether the usage of Rₐ is stereotypic, illustrated at 480. If the usage of Rₐ is stereotypic, block 490 shows that the current value of Rᵤ is written to the register file and a copy of the current value of Rᵤ and the operation to be performed on that value is stored in a recovery location.

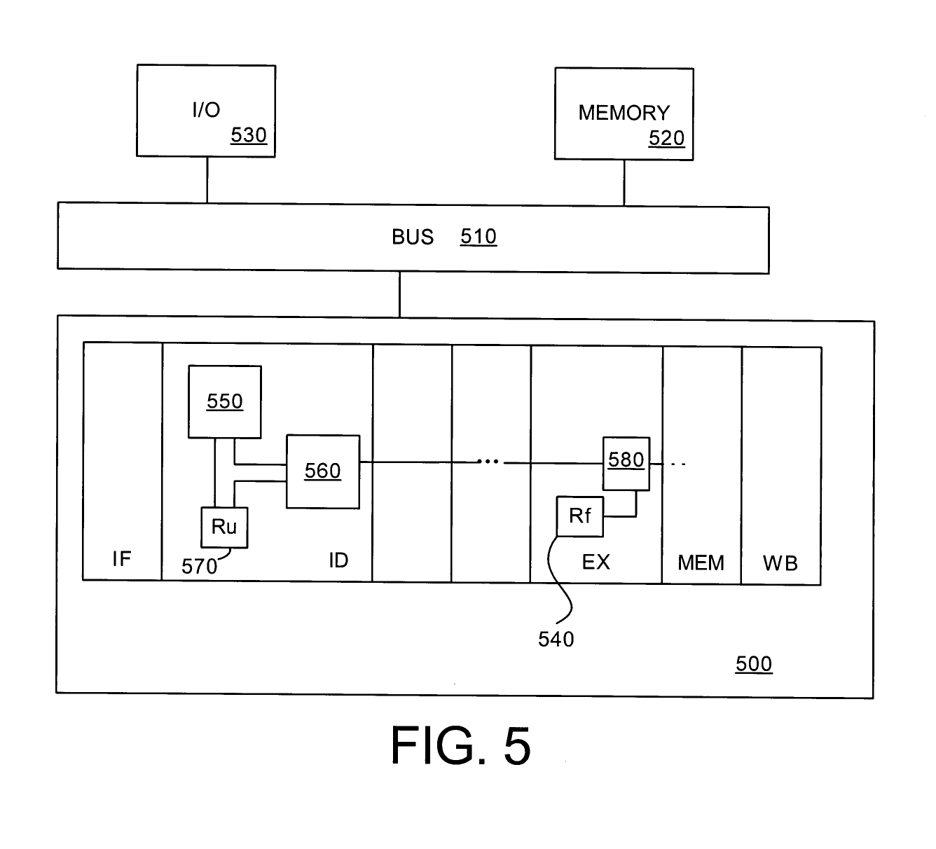

FIG. 5 is a block diagram of a pipelined processor containing circuitry for the distribution of architectural state information. Processor 500, I/O unit 530 and memory 520 are connected to bus 510. Processor 500 illustrates an example of several stages of a pipelined processor, including instruction fetch (IF), instruction decode (ID), execution (EX), memory (MEM), and write-back (WB). In one embodiment, register file 540 is maintained in the ID stage of the pipeline. The R_{f} register is maintained in register file 540.

The ID stage of the processor pipeline includes circuitry 550 for decoding instructions. Logic to effectuate the stereotypic behavior of Rₐ, including, for example, the logic of FIGS. 2 and 3, is indicated by 560. Rᵤ, also maintained in the ID stage, is indicated by register 570 and is connected to the logic in 560.

R_{f} register 540 is only seen by the execution unit(s) as R_{f} is added to Rᵤ to make Rₐ complete during a sync operation. In one embodiment R_{f} is “always ready” and Rᵤ can be updated multiple times per clock cycle, thus allowing many more memory operations to be executed in parallel.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

1. An apparatus comprising:
a pipelined processor having circuitry to perform multiple stages of instruction execution, wherein each stage selectively performs a predetermined set of operations in response to an instruction;
a historical register, coupled to the processor circuitry, to store a historical architectural value; and
an update register in a non-final pipeline stage to store an update value, wherein a sum of the update value and the historical architectural value corresponds to a current architectural value.

2. The apparatus of claim 1 wherein the architectural value comprises to a pointer value.

3. The apparatus of claim 2 wherein the pointer value comprises a stack pointer.

4. The apparatus of claim 1 wherein the non-final pipeline stage comprises a decode stage.

5. The apparatus of claim 4 wherein the decode stage circuitry comprises an adder to generate the update value.

6. The apparatus of claim 5 further comprising circuitry coupled with the decode stage circuitry to provide storage for a copy of the update value.

7. The apparatus of claim 6 wherein the circuitry providing storage for a copy of the update value is a reorder buffer.

8. The apparatus of claim 4 wherein the decode circuitry comprises circuitry to determine a change to the update value corresponding to a decoded instruction.

9. The apparatus of claim 4 wherein the decode stage circuitry comprises circuitry to determine if an instruction requires the current architectural value.

10. The apparatus of claim 1 wherein the register storing the historical architectural value is part of a register file.

11. The apparatus of claim 7 further comprising execution stage circuitry coupled with the register file to provide the current architectural value to the register.

12. A method comprising:
representing an architectural value of a register with a historical value stored in a first register and an update value maintained in a second register wherein the second register is part of a non-final pipeline stage;
storing a copy of the update value for each instruction and the operation to take place on that value;
determining when an instruction requires the architectural value for processing;
calculating the architectural value;
inserting the architectural value into the pipeline based on the determined need;

13. The method of claim 12 further comprising synchronizing the architectural value with the historical value when the architectural value is calculated and the update value is not equal to zero, or when potential overflow of the register is detected.

14. The method of claim 12 wherein the architectural value comprises a pointer value.

15. The method of claim 14 wherein the pointer value comprises a stack pointer.

16. The method of claim 12 further comprising sending the historical value through the execution core of the pipeline when the architectural value is not required.

17. The method of claim 12 wherein the machine for executing instructions comprises an out of order machine.

18. The method of claim 12 wherein the update value is generated by an adder.

19. The method of claim 12 wherein the non-final pipeline stage comprises a decode stage.

20. The method of claim 12 wherein storing the update value and the operation to take place on that value comprises storing the update value and the operation to take place on that value in a buffer.

21. The method of claim 12 wherein synchronizing the architectural value with the historical value comprises setting the update value to zero;

22. The method of claim 12 wherein detecting overflow comprises comparing the update value with a threshold value;

23. The method of claim 21 wherein comparing the update value to the threshold value comprises using a comparator;

24. The method of claim 12 further comprising:
retrieving a stored update value and the operation to take place on that value after it has been determined that a speculative path is erroneous;
calculating the architectural value using the retrieved update value and the operation to take place on that value;
inserting the architectural value into the pipeline to recover a desired machine state;

25. The method of claim 24 wherein the speculative path is a mispredicted branch;

26. The method of claim 24 wherein the speculative path is a page fault.

27. An apparatus comprising:
a pipelined processor having circuitry to perform multiple stages of instruction execution, wherein each stage selectively performs a predetermined set of operations in response to an instruction;
a historical register, coupled to the processor circuitry, to store a historical architectural value;
an update register in a non-final pipeline stage to store an update value, wherein a sum of the update value and the historical architectural value corresponds to a current architectural value; and
a memory controller coupled with the pipelined processor.

28. The apparatus of claim 27 wherein the architectural value comprises to a pointer value.

29. The apparatus of claim 28 wherein the pointer value comprises a stack pointer.

30. The apparatus of claim 27 wherein the non-final pipeline stage comprises a decode stage.
